(19) United States
(12) Patent Application Publication
(10) Pub. No.: US 2025/0257747 A1
(43) Pub. Date: Aug. 14, 2025

(54) Edge Clip with Lever Clamping Mechanism

(71) Applicant: Illinois Tool Works Inc., Glenview, IL (US)

(72) Inventors: Louay Kouzali, Kaiserslautern (DE); Nikolas Keilholz, Kolitzheim (DE); Kai Hamacher, Marktheidenfeld (DE)

(21) Appl. No.: 19/048,572

(22) Filed: Feb. 7, 2025

(30) Foreign Application Priority Data
Feb. 9, 2024 (DE) 10 2024 103 725.3
Jan. 22, 2025 (DE) 10 2025 102 321.2

(51) Int. Cl. F16B 2/18; B29C 45/00; B29L 31/00; F16L 3/137

(52) U.S. Cl. CPC F16B 2/185; B29C 45/0017; F16L 3/137; B29L 2031/727; F16B 2200/63

(57) ABSTRACT

Disclosed is a fastening device, in particular an edge clip, for fastening a first component to a second component, preferably a plate-shaped element is provided. The fastening device includes a base body that delimits an approximately U-shaped receiving space for receiving a portion of a second component. One leg of the U-shaped receiving space forms a first fastening wall and a second leg opposite to the first leg of the receiving space forms a second fastening wall and a lever element for applying a compressive force to one of the two fastening walls that acts in the direction of the other fastening wall in such a way that the fastening device is connected to a second component via the fastening walls.

### RELATED APPLICATIONS

The present application claims the benefit of German Patent Application Nos. 10 2024 103 725.3, filed Feb. 9, 2024, and 10 2025 102 321.2, filed Jan. 22, 2025, each titled “Edge Clip with Lever Clamping Mechanism,” the contents of which are hereby incorporated by reference.

### BACKGROUND

Edge clips or edge clamps are often used, for example in the automotive industry, in areas where fastening holes and other fastening means (e.g., adhesives or the like) are not acceptable. Such clips are widely used for fastening and also bundling cables, pipes, and hoses. Such edge clips typically have a U-shaped metal clamp that comprises corresponding teeth or latching claws on the inner side of the legs that form the U-shaped gap for receiving an object (e.g., a wall region of the body).

These latching claws are aligned in such a way that they bend open when the component is inserted in an insertion direction but spread apart in the opposite direction when the component is pulled out. Any attempt to remove the edge clip can therefore damage the component or at least a protective coating applied to the component (e.g., paintwork). If the clip nonetheless has to be removed (e.g., during repair or servicing of the vehicle), it is often irreparably damaged, so that new edge clips or clamps are required for reassembly.

Example edge clips are described in EP4249757A1 to Grube et al. and assigned to Nexans SA, DE2020/22100676U1 assigned to HellermannTyton GmbH, DE2020/21105021U1 assigned to HellermannTyton GmbH, and EP4131687A1 to Miraboutalebi and assigned to Hellermann Tyton GmbH.

Despite advancements to date, a need exists for an improved fastening device, such as an edge clip, for fastening a first component to a second component.

### SUMMARY

The present disclosure relates generally to a fastening device, substantially as illustrated by and described in connection with at least one of the figures, as set forth more completely in the claims. More specifically, an edge clip, for fastening a first component to a second component.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic, perspective view of a fastening device according to the disclosure in an open position.

FIG. 2 illustrates a perspective view of the fastening device according to the disclosure when connecting to a second component in an open position.

FIG. 3 illustrates a perspective view of the fastening device according to the disclosure, disposed on a second component.

FIG. 4A illustrates a perspective view of the fastening device according to the disclosure on the component with the lever element in the open position (the arrow indicates the direction of rotation of the lever).

FIG. 4B illustrates a perspective view of the fastening device according to the disclosure on the component with the lever element in the securing position or in a final assembly position.

FIG. 5A illustrates a plan view from above onto the fastening device according to the disclosure with the lever element in an open position.

FIG. 5B illustrates a plan view from above onto the fastening device according to the disclosure with the lever element in a securing position, i.e., closed position or final assembly position.

FIG. 6A illustrates a second, alternative embodiment of the fastening device according to the disclosure (e.g., an edge clip) in the open state in side view.

FIG. 6B illustrates a second, alternative embodiment of the fastening device according to the disclosure in the open state in front view.

FIG. 6C illustrates a second, alternative embodiment of the fastening device according to the disclosure in the open state in plan view.

FIG. 6D illustrates a second, alternative embodiment of the fastening device according to the disclosure in the open state in bottom view.

FIG. 7A illustrates perspective views of an alternative embodiment of the fastening device according to the disclosure with the lever element in the open position.

FIG. 7B illustrates perspective views of an alternative embodiment of the fastening device according to the disclosure mounted on a component and the lever element is rotated in the direction of the securing position (the arrow indicates the direction of rotation).

FIG. 7C illustrates perspective views of an alternative embodiment of the fastening device according to the disclosure, mounted on a component and snapped into place with the lever element in the securing position.

FIG. 8A illustrates perspective sectional views of the alternative embodiment of the fastening device according to the disclosure mounted on a component with the lever element in the open position.

FIG. 8B illustrates perspective sectional views of the alternative embodiment of the fastening device according to the disclosure mounted on a component with the lever element between the open position and the securing position (the arrow indicates the direction of rotation).

FIG. 8C illustrates perspective sectional views of the alternative embodiment of the fastening device according to the disclosure mounted on a component with the lever element snapped into place in the securing position.

FIG. 8D illustrates perspective sectional views of the alternative embodiment of the fastening device according to the disclosure mounted on a component with a side profile of a side wall.

FIG. 9A illustrates a plan view from above onto the alternative embodiment of the fastening device according to the disclosure with the lever element in the securing position, i.e., closed position or final assembly position.

FIG. 9B illustrates a plan view from above onto the alternative embodiment of the fastening device according to the disclosure with the lever element in a position between the open position and the securing position.

FIG. 9C illustrates a plan view from above onto the alternative embodiment of the fastening device according to the disclosure with the lever element in an open position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “connected,” “attached,” “coupled,” “mounted” moreover each describe direct connections between two elements or components, i.e., without an intermediate element, but also indirect connections between elements or components, i.e., with at least one intermediate element.

The object of the present disclosure is to provide a fastening device, in particular an edge clip, for fastening a first component to a second component and a method for producing it, that enable damage-free assembly.

A further object of the present disclosure is to create a fastening device, in particular an edge clip, for fastening a first component to a second component and a corresponding method for producing it, that represents an alternative to edge clips and methods known from the prior art.

It is also an object of the present disclosure to provide a fastening device, in particular an edge clip, for fastening a first component to a second component and a method for producing it, that is simple in design and easy to produce.

According to the disclosure, a fastening device, in particular an edge clip, for fastening a first component to a second component, preferably a plate-shaped element is provided. It comprises a base body which delimits an approximately U-shaped receiving space for receiving a portion of a second component, wherein a first leg of the U-shaped receiving space forms a first fastening wall and a second leg opposite to the first leg of the receiving space forms a second fastening wall and a lever element for applying a compressive force to one of the two fastening walls which acts in the direction of the other fastening wall in such a way that the fastening device is connected to a second component via the fastening walls.

As already mentioned, the known edge clips or edge clamps are usually made of a bent metal sheet with corresponding hooks, the edges of which grip the material of the metal sheet during assembly and in particular during disassembly. This can damage coatings and/or paintwork.

These types of edge clips already damage the surface of the material during disassembly. Disassembly causes further damage, in particular scratches and grooves in the surface of the sheet metal.

The fastening device according to the disclosure has a U-shaped receiving space in which a portion of a second component, in particular a metal sheet or a plate-shaped element, can be disposed. To then achieve a final assembly position, the lever element can be used to apply a compressive force to one of the two fastening walls which acts in the direction of the other fastening wall in such a way that the fastening device is connected by means of the compressive force and the frictional force to a second part of the component via the fastening wall.

The fastening device according to the disclosure is not only an alternative to known fastening devices made of metal, since it is preferably made of plastic, but also a releasable fastening device that can be easily attached to the component (e.g., without scratches or dents) and removed again without potentially damaging the component or the clip.

The fastening device according to the disclosure is also extremely simple in design and reliable in its mechanical function; i.e., the “soft” retaining elements can be pressed onto the component with a suitable compressive force via an appropriately adapted eccentric portion to fix the edge clip in the desired position.

The lever element can be rotatably mounted in the base body and can be disposed in an open position to receive a second component and in a securing position to connect to a second component.

This makes it easy to connect the fastening device to the second component and also release it again, because only a simple lever mechanism is provided for this process.

The lever element can comprise an eccentric portion for applying the compressive force acting in the direction of the first fastening wall to the second fastening wall, and a lever portion, which is in particular integrally connected thereto, for rotating the eccentric portion.

Rotating the lever portion presses the eccentric portion, in particular a pressure portion of the eccentric portion, more and more in the direction of the second fastening wall until it rests against the second fastening and then, in the final assembly position, the second fastening wall is subjected to a compressive force acting in the direction of the first fastening wall. The fastening device can thus be securely and reliably connected to a component.

The first fastening wall can be fixedly disposed on the base body and the second fastening wall can be pivotably connected to the base body.

This means that the second fastening wall is connected to the base body in a lever-like or articulated or elastically pivotable manner and can move in the direction of the first fixed fastening wall. After the compressive force is removed (by the eccentric lever), an elastically integrally formed second fastening wall automatically moves back to the starting position (i.e., the fastening device is again in the open position).

A first and a second plate-shaped retaining element made of a soft component can respectively be disposed on the first and the second fastening wall toward the receiving space. The base body and the lever element can preferably be made of a hard component.

The plate-shaped retaining elements made of a soft component significantly increase the frictional force between the retaining elements of the boundary wall and a surface of a second component, which makes it possible to provide higher holding forces.

A rotating shaft can be integrally formed on the lever portion and rotatably mounted in corresponding bearing recesses of the base body.

This enables a simple design of the fastening device according to the disclosure.

At least one latching element can be disposed on a free end of the lever portion to connect the lever element in the securing position, in particular in the final assembly position, to at least one correspondingly configured latching edge of the base body.

Providing the latching element and the correspondingly configured latching edge makes it possible to reliably ensure the securing position, in particular a final assembly position.

In one embodiment of the disclosure, the lever portion can comprise two lever arms that extend parallel from the rotating shaft, wherein a respective latching element is disposed on the respective end region of the two lever arms. The two lever arms are in particular disposed spaced apart to one another and resiliently deflectably on the rotating shaft such that the respective latching element in the securing position can be released from contact with the corresponding latching edge.

Disposing the latching elements in such a way that they can be released from one another enables the lever element to be secured during final assembly in the simplest possible way and with minimal wear and also released again from the securing position.

The eccentric portion of the lever element can be configured such that it applies a compressive force to the second fastening wall during the transition from the open position to the securing position, whereby rotating the lever portion initially reduces a distance between a pressure surface of the eccentric portion and the second fastening wall until it is pressed against the second fastening wall and further rotation increases the compressive force such that the second fastening wall is pivoted in the direction of the first fastening wall. This increases the pressing force on the component.

Means for receiving a fastening element, in particular a cable tie, or a fastening element itself, such as a cable holder or a pipe holder, or a different type of retaining element can be formed on the base body.

A method for producing a fastening of a fastening device shown above is provided according to the disclosure as well.

The fastening device is produced by means of a two-component injection molding process from a hard component and a soft component which are both made of plastic, and wherein a base body and a lever element of the fastening device are formed in a single-stage or multi-stage manufacturing process such that the lever element is connected to the base body via at least one and preferably multiple webs that form preset breaking points.

The fastening device according to the disclosure can therefore be easily produced in a single manufacturing process in a single machine.

This also has the advantage that the fastening device can always be delivered to customers in the same open or starting position.

When used for the first time then, the respective webs or the preset breaking points in the webs break, so that the lever element is rotatably mounted in the base body.

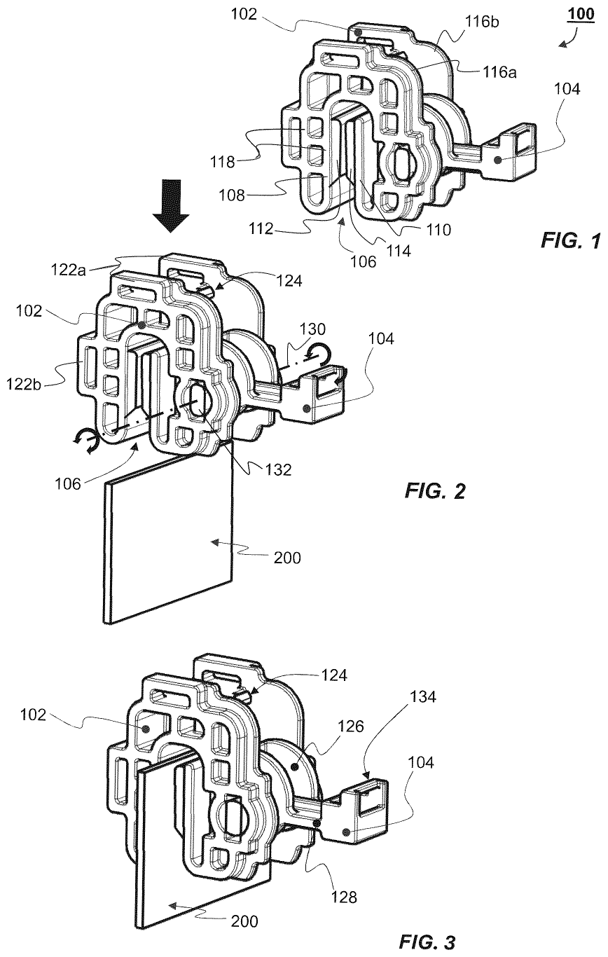

A first embodiment of the fastening device 100 according to the disclosure, in particular an edge clip, for fastening a first component (e.g., hoses, cables, etc.) to a second component 200 (e.g., vehicle frame with relatively flat edges, etc.) is described in more detail in the following using an embodiment example (FIGS. 1-5).

The fastening device 100 comprises a base body 102 and a lever element 104 which is rotatably mounted in said base body. In a starting position (the open lever position), the fastening device 100 is in an open state, i.e., the second component 200 (the edge of a flat steel or plate) can be pushed into a receiving space 106 of the U-shaped clip 200 without much resistance.

The base body 102 thus delimits the approximately U-shaped receiving space 106, wherein a first leg of the base body 102 delimiting the U-shaped receiving space 106 is fixedly disposed and forms a first delimiting or fastening wall 108. A second leg of the base body 102 delimiting the receiving space 106 is fixedly disposed parallel to the first leg, and a second delimiting or fastening wall 110 is rotatably or pivotably connected to a free end of the second leg. In the example discussed here, the rotatability or pivotability of the second fastening wall 110 is realized via an elastic connection between the base body 102 (i.e., the second leg) and the second fastening wall 110, so that the second fastening wall 110 can be deflected in a resilient manner.

A first and a second plate-shaped retaining element 112, 114 are respectively disposed on the surfaces of the first and second fastening walls 108, 110 facing in the direction of the receiving space 106. The first retaining element 112 and the second retaining element 114 are made of a plastic soft component. The base body 102 itself is made of a plastic hard component.

The base body 102 and retaining elements 112, 114 of the fastening device 100 according to the disclosure can thus be produced together from two different plastics using a two-component injection molding process.

As shown in FIGS. 1 to 3, the base body 102 consists substantially of two opposite and parallel side walls 116a, 116b, which are connected to one another via a plurality of struts 118 or ribs that extend orthogonally to the side walls 116a, 116b. These struts 118 also form the fastening walls 108, 110, for instance.

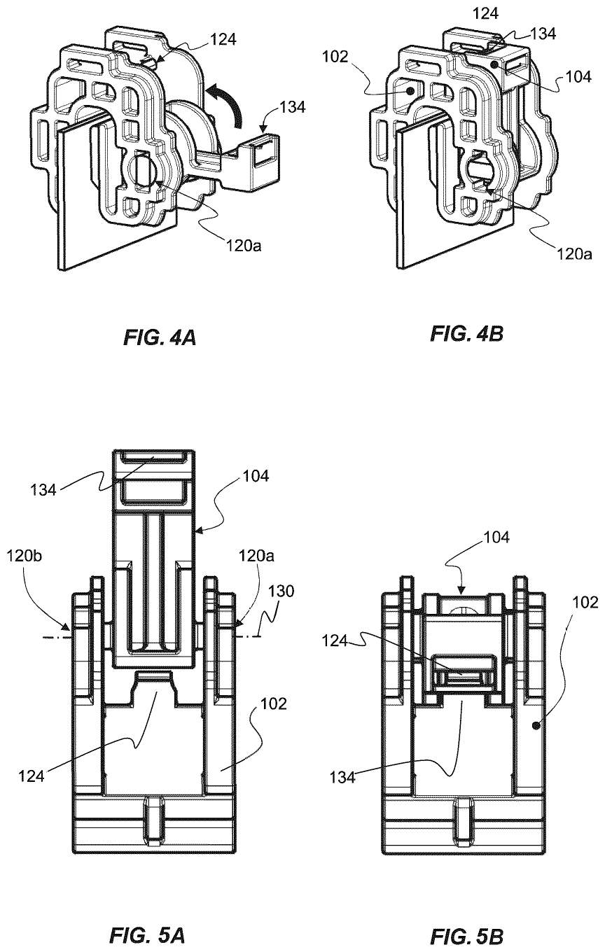

Keyhole-like bearing recesses 120a, 120b for receiving the lever element 104 are formed in the side walls 116a, 116b in a region close to the second pivotable fastening walls 110. In the example presented here, the bearing recesses 120a, 120b on the respective side wall 116a, 116b are disposed congruently and coaxially to one another. As shown in FIGS. 4a and 4b, for example, the bearing recess 120a, 120b consists of a centrally disposed cylindrical opening that is overlaid with a cuboid aperture in such a way that a keyhole-like bearing receptacle matching a corresponding shaft portion 132a, 132b of the lever element 104 is formed. The respective shaft portion 132a, 132b is a projection having a rectangular cross-sectional profile that fits into the cuboid aperture, wherein the long side length of the rectangular cross-sectional profile is adjusted according to the diameter and the short side of the rectangular cross-sectional profile to the circle profile of the cylindrical opening in such a way that the shaft portion 132a, 132b engages in the cylindrical opening in a rotatably mounted manner (i.e., when the lever element 104 is rotated to the securing position).

According to the present embodiment example, means 122a, 122b (e.g., a fastening tab) for receiving a fastening element, in particular a cable tie, are formed on at least the side of the base body 102 opposite to the receiving space 106 and the second fastening wall 110. On the side of the base body 102 opposite the receiving space 106, one of the struts 118 that connect the two side walls 116a, 116b to one another forms a latching edge 124 (or also a latching tooth) for securing the lever element 104 in a secured position (i.e., in the closed state) or a final assembly position. The latching edge 124 is configured such that a corresponding latching element 134 disposed on the lever element 104 can snap in in a fastening manner in the securing position.

The lever element 104 further comprises an eccentric portion 126 and a lever portion 128 which is integrally connected thereto. The latching element 134 designed to correspond to the latching edge 124 is disposed on the free end of the lever portion 128 in such a way that it snaps elastically into the latching edge 124 (or the latching tooth) when the lever element 104 is pivoted and is thus fixed.

The eccentric portion 126 comprises a rotating shaft 130 formed by the two shaft portions 132a, 132b that extend on the lever portion 128 in the direction of the side wall 116a, 116b. During the manufacturing process, the shaft portions 132a, 132b are preferably connected to the bearing recesses 120a, 120b via webs (not shown) that form the preset breaking points. The shaft portions 132a, 132b or the rotating shaft 130 of the eccentric portion 126 (and the lever element 104) are thus rotatably mounted in the bearing recesses 120a, 120b. The lever element 104 is therefore rotatably connected to the base body 102.

As shown in more detail in FIGS. 4A and 4B, in the securing position, due to its structural design, the eccentric portion 126 applies a compressive force acting in the direction of the first fastening wall 108 to the second fastening wall 110, so that the second fastening wall 110 is pressed against the inserted second component 200. FIGS. 5A and 5B show a plan view of the edge clip 100.

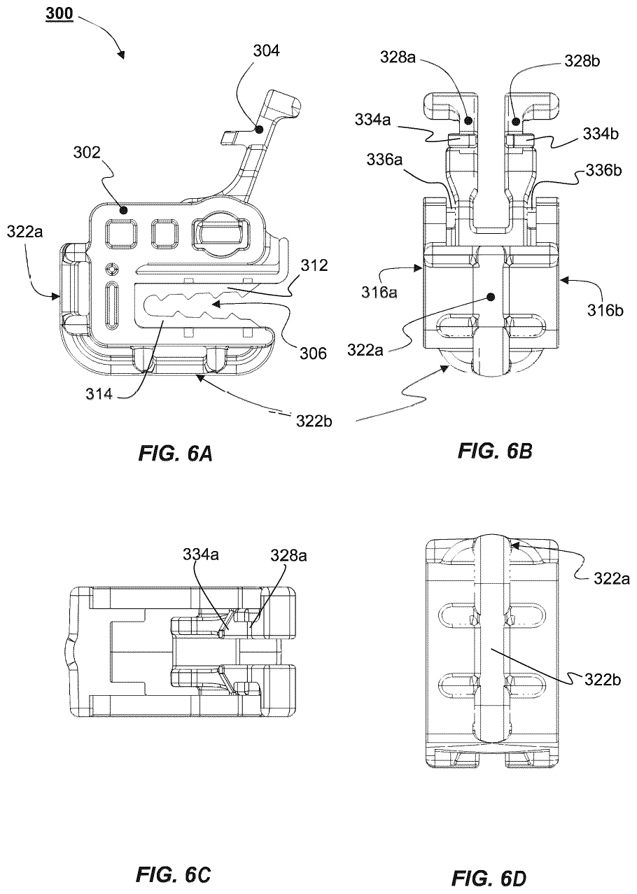

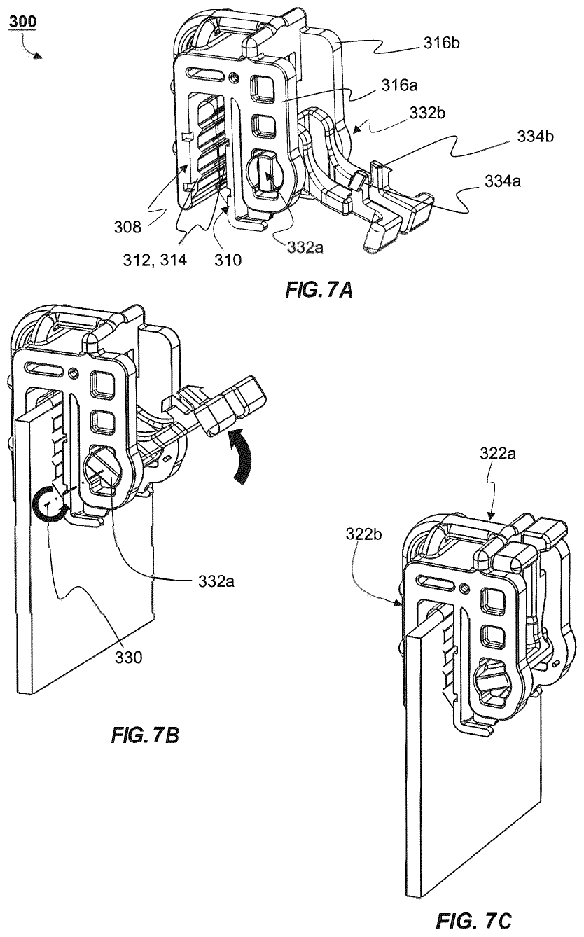

A second alternative embodiment of the fastening device 300 according to the disclosure, in particular an edge clip, for fastening a first component (e.g., hoses, cables, etc.) to a second component 200 (e.g., vehicle frame with relatively flat edges, etc.) is described in more detail in the following using another embodiment example and FIGS. 6A-6D through 8A-8D.

The second, alternative embodiment of the fastening device 300 is essentially the same as the first embodiment of the fastening device 100, i.e., the basic construction and mode of operation are identical except for a few differences. Therefore, primarily the functional and structural differences to the first embodiment are described for the second embodiment. For the identical or similar components, reference is made to the description of the first embodiment. Correspondingly adapted reference signs are used in the second embodiment 300 for the components that are identical to the first embodiment 100; e.g., the base body 102 of the first embodiment 100 differs from the base body 302 of the second embodiment only insignificantly in terms of its external design and therefore does not have to be described in more detail for the second embodiment. The features of the second embodiment 300 that are distinguishable from the first embodiment 100 will be described in more detail in the following.

As shown in FIGS. 6A through 6D, the second alternative fastening device 300 comprises a base body 302 and a lever element 304 rotatably mounted therein. In a starting position, the lever element 304 is open and the fastening device 300 is in an open state. As in the first embodiment 100, the lever element 304 can be rotated from the open state (starting position) to a closed state (securing position) toward the base body 302 and can be fixed in the securing position to corresponding latching edges 324 via releasable latching elements 334.

As in the first embodiment 100, the base body 302 consists of first and second side walls 316a, 316b which are connected via struts 318 disposed orthogonally to the side walls such that a fixedly disposed first and second leg delimits a U-shaped receiving space 306. The legs each comprise a first delimiting or fastening wall 308, 310 facing the receiving space 306. The second delimiting or fastening wall 310 is rotatably or pivotably (e.g., elastically deflectably) connected to the base body 302. The second fastening wall 310 is in particular disposed in the receiving space 306 on the base body 302 spaced apart parallel to the second leg. The second fastening wall 310 can thus be deflected in a resilient manner with respect to the second leg of the base body 302.

As in the first embodiment 100, a respective first and a second plate-shaped retaining element 312, 314 are disposed on the surfaces of the first and second fastening walls 308, 310 facing in the direction of the receiving space 306. Here, too, the first and second retaining element 312, 314 are made of a plastic soft component and the base body 302 is made of a plastic hard component.

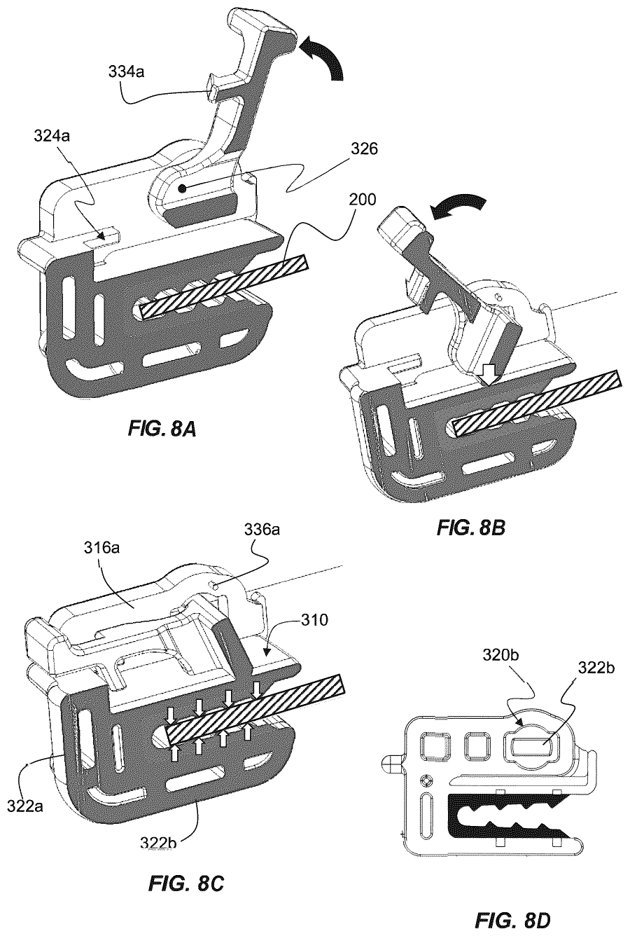

The side walls 316a, 316b each comprise the keyhole-like bearing recesses 320a, 320b for receiving the lever element 304. FIG. 8D shows a side view of the side wall 316a and the keyhole-like bearing recess 320a, which, as already described for the first embodiment 100, is formed from overlaid cylindrical and cuboid openings or apertures, wherein the rectangularly shaped shaft portion 332a, 332b of the lever element 304 can engage in the cylindrical opening in a rotatably mounted manner.

Corresponding fastening means 322a, 322b in the form of closed brackets or tabs are respectively disposed on the free (i.e., opposite to the lever element 304 and the receiving space 306) outer surfaces of the base body 302 (see FIGS. 6A-D).

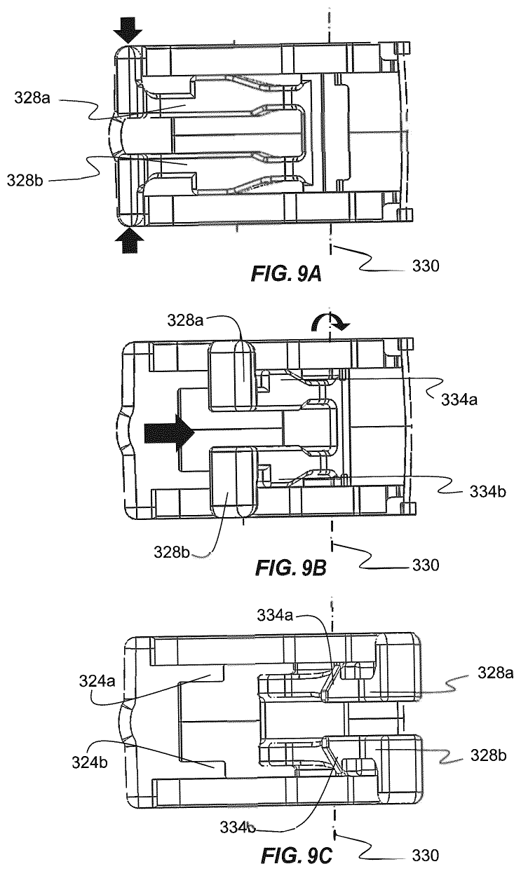

The lever element 304 of the second embodiment 300 consists of two lever arms 328a, 328b that extend parallel to one another from the shaft portion 332a, 332b and can be elastically deflected relative to one another. A latching element 334a, 334b is disposed on each yoke end of the lever arms 328a, 328b in such a way that the latching elements 334a, 334b can respectively engage in a fastening manner in a corresponding latching edge 324a, 324b of the first and second side walls 116a, 116b. The latching elements 334a, 334b can be removed from engagement with the latching edges 324a, 324b by deflecting the lever arms 328a, 328b, i.e., by simply pressing the elastically deflectable lever arms 328a, 328b together, so that the lever element 304 can be rotated back to the open starting position. This process is shown in particular in FIGS. 9A through 9C. However, those skilled in the art will appreciate that any other type of latch or clamp closure that releasably fixes the lever can be used for the present disclosure as well. The lever can therefore be fork-shaped or made in one piece without departing from the concept of the present disclosure.

A method for producing the fastening device 100, 300 shown above is provided according to the disclosure as well.

The fastening device 100, 300 is produced by means of a two-component injection molding process from a hard component and a soft component which are both made of plastic.

A base body 102, 302 and a lever element 104, 304 of the fastening device 100, 300 are formed in a single-stage or multi-stage manufacturing process (single-stage or multi-stage two-component injection molding process) such that the lever element 104, 304 is connected to the base body 102, 302 at least initially via at least one and preferably multiple webs 336 that form preset breaking points (see FIGS. 6B, 7B, 7C, 8B, and 8C).

The use of the fastening device 100, 300 according to the disclosure can be briefly summarized as follows. The present disclosure therefore relates to an edge clip for fastening an object to an edge of another object. Edge clamps are typically made of a metal sheet that is bent in such a way that it grips the material of the edge when it is pulled off and can thus cause obvious damage.

In contrast, the concept of the present disclosure is based on frictional force over the entire surface that results from pressing a soft part onto a plate-shaped component. The necessary contact pressure is generated by rotating a lever element 104, 304 comprising an eccentric portion 126, 326 that, when rotated, reduces the distance to the second fastening wall 110, 310 such that a contact surface of the eccentric portion 126, 326 presses onto the edge surface and further rotation can increase the compressive force. The eccentric portion 126, 326 is preferably configured such that the second fastening wall 110, 310 is pressed onto the component 200 with a desired pressure when the lever element 104, 304 is fixed in its securing position. When the fastening device or edge clip 100, 300 is fixed/installed on the edge 200, cables, hoses, or the like can be fastened via the fastening tabs or fastening brackets 122a, 122b, 322a, 322b provided on the edge clip, e.g., using cable ties.

The edge clip 100, 300 can moreover be removed and reused in the simplest possible way and without the risk of damaging the component or edge clip 100, 300. To do this, the lever element 104, 304 is simply released from the connection with the latching edge(s) 124, 324 and rotated to the open position. The pressure applied by the eccentric portion 126, 326 to the second fastening wall 110, 310 is thus removed and the second fastening wall 110, 310 which is deflected in the direction of the component 200 returns (elastically) to the starting position. This removes the contact pressure between the retaining elements 112, 114, 312, 314 and the component 200 and the edge clip 100, 300 can be pulled off the component 200 without much resistance.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

Fastening device 100, 300
Base body 102, 302
Lever element 104, 304
Receiving space 106, 306
First boundary wall 108, 308
Second boundary wall 110, 310
First retaining element 112, 312
Second retaining element 114, 314
Side wall 116a, 316a
Side wall 116b, 316b
Strut(s) 118, 318
Bearing recess 120a, 320a
Bearing recess 120b, 320b
Fastening means 122a, 322a
Fastening means 122b, 322b
Latching edge 124
Latching edges 324a, 324b
Eccentric portion 126, 326
Lever portion 128
Lever arms 328a, 328b
Rotating shaft 130, 330
Shaft portion(s) 132a,b, 332a,b
Latching element(s) 134, 334a, 334b
Webs 336a, 336b

What is claimed is:

1. A fastening device for fastening a first component to a second component comprising
a base body which delimits an approximately U-shaped receiving space for receiving a portion of a second component, wherein a first leg of the U-shaped receiving space forms a first fastening wall and a second leg opposite to the first leg of the receiving space forms a second fastening wall, and
a lever element for applying a compressive force to one of the first and second fastening walls which acts in a direction of the other fastening wall in such a way that the fastening device is connected to a second component via the fastening walls.

2. The fastening device according to claim 1, wherein the lever element is rotatably mounted in the base body and can be disposed in an open position to receive a second component and in a securing position to connect to a second component.

3. The fastening device according to claim 2, wherein the lever element comprises an eccentric portion for applying the compressive force acting in a direction of the first fastening wall to the second fastening wall and a lever portion for rotating the eccentric portion.

4. The fastening device according to claim 3, wherein the first fastening wall is fixedly disposed on the base body and the second fastening wall is pivotably connected to the base body.

5. The fastening device according to claim 1, wherein a first and a second plate-shaped retaining element made of a soft component are respectively disposed on the first and the second fastening wall toward the receiving space, and wherein the base body and the lever element are made of a hard component.

6. The fastening device according to claim 3, wherein a rotating shaft is integrally formed on the lever portion and is rotatably mounted in corresponding bearing recesses of the base body.

7. The fastening device according to claim 6, wherein at least one latching element is disposed on a free end region of the lever portion to connect the lever element in the securing position to at least one correspondingly configured latching edge of the base body.

8. The fastening device according to claim 7, wherein the lever portion comprises two parallel lever arms that extend from the rotating shaft, wherein a respective latching element is disposed on the respective end region of the two lever arms.

9. The fastening device according to claim 8, wherein the two lever arms are disposed spaced apart parallel to one another and resiliently deflectably on the rotating shaft such that the respective latching element in the securing position can be released from contact with the corresponding latching edge.

10. The fastening device according to claim 4, wherein the eccentric portion of the lever element is configured such that a compressive force is applied to the second fastening wall during the transition from the open position to the securing position, and rotating the lever portion toward the securing position initially reduces a distance between a pressure surface of the eccentric portion and the second fastening wall until it is pressed against the second fastening wall and further rotation increases the compressive force such that the second fastening wall is pivoted in the direction of the first fastening wall.

11. The fastening device according to claim 1, wherein means for receiving a fastening element or a fastening element itself are formed on the base body.

12. The fastening device according to claim 1, wherein the second component is a plate-shaped element.

13. The fastening device according to claim 1, wherein the fastening device is an edge clip.

14. The fastening device according to claim 11, wherein the fastening element is a cable tie.

15. A method for producing a fastening device according to claim 1,
wherein the fastening device is produced by means of a two-component injection molding process from a hard component and a soft component which are both made of plastic, and
wherein a base body and a lever element of the fastening device are formed in a single-stage or multi-stage manufacturing process such that the lever element is connected to the base body via at least one web that forms one or more preset breaking points.
